(19) United States
(12) Patent Application Publication
(10) Pub. No.: US 2012/0275444 A1
(43) Pub. Date: Nov. 1, 2012

(54) PUSH-TO-MULTIMEDIA METHOD AND SYSTEM FOR SHARING MULTIMEDIA INFORMATION

(76) Inventor: SALAH SHAHSAVARI, Tehran (IR)

(21) Appl. No.: 13/236,671

(22) Filed: Sep. 20, 2011

Related U.S. Application Data
(60) Provisional application No. 61/479,973, filed on Apr. 28, 2011.

(51) Int. Cl. H04W 92/00

(52) U.S. Cl. 370/338

(57) ABSTRACT

The various embodiments herein provide a Push-to-Multimedia (PTM) method and system for sharing multimedia information between users of a cellular network. The method comprising installing a PTM application on at least one user device, connecting the at least one user device to a Push-To-Multimedia server through a network interface, registering the at least one user device in the Push-To-Multimedia server, an authentication server for authenticating the at least one user device, verifying the at least one user devices in a Group and List Management Server, selecting at least one target user, creating a PTM connection file, connecting the PTM connection file to the PTM server by a verification headers, sending a connection request to the at least one target users and creating a real time multimedia connection on receiving a confirmation from the at least one target user.

### CROSS-REFERENCE TO RELATED APPLICATIONS

This application claims the benefit of U.S. provisional patent application Ser. No. 61/479,973, filed Apr. 28, 2011, which is incorporated herein by reference in its entirety.

### BACKGROUND

1. Technical Field

The embodiments herein generally relate to multimedia communication systems and methods and particularly to multimedia communication over a cellular network. The embodiments herein more particularly relates to a Push-To-Multimedia service on an IP multimedia system over the cellular network.

2. Description of the Related Art

Communication sessions are conventionally initiated either as half-duplex sessions (e.g., PTT) or full-duplex sessions (e.g., VoIP). When a synchronous, full-duplex communication is desired between two telecommunication devices, such as a telephone call between two telephones, it is common that one device attempt to start the communication and bridge the connection by contacting the other device. The telephone system then will either send a signal and/or bridge a full-duplex communication channel over a circuit switch to the other device, and the contacted device will then broadcast an alert, such as a ring or other audible alert, and can also give a visual alert, such as flashing lights or activity on a display, to inform a person near the device that another communication device is attempting to bridge a communication. A person will then answer the contacted device and the full-duplex communication will then be bridged, or if the communication was already bridged, the channel will be maintained.

There is a wireless telecommunication service that provides a quick one-to-one or one-to-many half-duplex voice group communication that is generically referred to as “Push-To-Talk” (PTT). The specific PTT group of recipient devices for the communicating wireless device is commonly set up by the carrier, and a PTT communication connection is typically initiated by a single button-push on the wireless device that activates a half-duplex communication link between the speaker and each member device of the group. Once the button is released, the device receives the incoming PTT transmissions. In some arrangements, the PTT speaker will have the “floor” where no other group member can speak while the speaker had engaged the PTT button at his or her device. Once the speaker releases the PTT button, any other individual member of the group can engage their PTT button and they will have the floor.

There exists a need for a Push-to-Multimedia system and method, which allows its users to establish a multimedia connection among themselves through a server only by pressing or touch a “Multimedia (PTM)” key, entering a symbol or a name. There also exists a need for the Push-to-Multimedia connection able to be created from One-to-One or from One-to-group, in the form of a half-duplex through a telecommunication media.

The abovementioned shortcomings, disadvantages and problems are addressed herein and which will be understood by reading and studying the following specification.

### OBJECTIVES OF THE EMBODIMENTS

The primary object of the embodiments herein is to provide a Push-to-Multimedia (PTM) method and system which enables users to establish a multimedia connection with each other through a server application.

Another object of the embodiments herein is to provide a Push-to-Multimedia (PTM) method and system which enables users to establish a multimedia connection by entering a mobile number or a user name.

Yet another object of the embodiments herein is to provide a Push-to-Multimedia (PTM) system and method, which enables users to establish a multimedia connection by entering a cell ID.

Yet another object of the embodiments herein is to provide a Push-to-Multimedia system and method to establish at least one of a one-to-one communication, one-to-group communication in the form of a half-duplex connection over a telecommunication media.

Yet another object of the embodiments herein is to provide a Push-to-Multimedia system and method to establish an interactive multimedia communication.

Yet another object of the embodiments herein is to provide a Push-to-Multimedia system and method to establish a non-interactive multimedia communication.

Yet another object of the embodiments herein is to provide a Push-to-Multimedia system and method to establish an interactive data communication.

Yet another object of the embodiments herein is to provide a Push-to-Multimedia system and method to establish a non-interactive data communication.

Yet another object of the embodiments herein is to provide a Push-to-Multimedia system and method to establish an Ad-hoc group communication.

Yet another object of the embodiments herein is to provide a Push-to-Multimedia system and method to establish a pre-arranged group communication.

Yet another object of the embodiments herein is to provide a Push-to-Multimedia (PTM) system and method to establish a chat group communication.

These and other objects and advantages of the present invention will become readily apparent from the following detailed description taken in conjunction with the accompanying drawings.

### SUMMARY

The various embodiments herein provide a Push-to-Multimedia (PTM) method for sharing multimedia information between at least one user device and a target device or a plurality of user devices and target devices. The PTM method includes installing PTM application on at least one user device, connecting the at least one user devices to a Push-To-Multimedia (PTM) server through a network interface, registering the at least one user device in the Push-To-Multimedia server, authenticating the at least one user device, verifying the at least one user device in a Group and List Management Server (GLMS), selecting at least one target user, creating a PTM connection file, connecting the PTM connection file to the PTM server by a verification headers, sending a connection request to the at least one target user and creating a real time multimedia connection on receiving a confirmation from the at least one target user.

According to an embodiment herein, the multimedia information comprises at least one of streaming video, broadcast video, voice, digital data, text, digitized audio, digitized still images, digitized video and digitized music.

According to an embodiment herein, the multimedia information is shared between the users of a cellular network through at least one of a one-to-one connection, a one-to-group connection, an interactive connection and a non-interactive connection. The sharing of the multimedia information between the users of a cellular network is in the form of half duplex transmission.

According to an embodiment herein, the multimedia connection is created between the plurality of users and the PTM server by at least one of pressing a button, choosing a mark and entering a name/number in the mobile device.

According to an embodiment herein, the authentication of the at least one user device includes identifying International Mobile Subscriber Identity, International Mobile Equipment Identity and Mobile and Cell ID.

According to an embodiment herein, the verification of the at least one user device in the Group and List Management Server includes identifying a Cell ID, a Mobile Network Code (MNC), a Mobile Country Code (MCC), a Local Area Code (LAC), an International Mobile Equipment Identity (IMEI) and an International Mobile Subscriber Identity (IMSI) associated with the user devices.

According to an embodiment herein, the PTM connection file is created for the user device to establish a multimedia communication when the user device initiates a multimedia connection or sends a message by selecting one or more target users to the PTM server.

According to an embodiment herein, the access confirmation of the user device and verification of the Cell ID is carried out when the user device initiates a multimedia connection or sends a message by selecting one or more target users to the PTM server.

According to an embodiment herein, the PTM server starts sending the connection request for a one-to-one communication or a one-to-group communication of the target users based on the connection file.

According to an embodiment herein, the PTM application is pre-installed in the one or more target user devices wherein the one or more target user devices receives the connection request only when the PTM application is active and the contact information of the target user device is stored in the PTM server.

According to an embodiment herein, the PTM server stores a stream of multimedia data sent to the target user in the memory/inbox of the PTM server, when the target user does not answer to the connection request.

According to an embodiment herein, the PTM server informs the user device on a regular basis about a streaming of multimedia data sent to the target user.

According to an embodiment herein, the PTM server sends an message to a target user's contact number to inform about the multimedia connection, when the target user's contact number specified by the user is not stored in the PTM server. The message informs the target user of having the PTM message and provides a download option for a PTM application for receiving the PTM message.

According to an embodiment herein, after each PTM connection, the target user contact number and the PTM message information is updated in the PTM server.

According to an embodiment herein, the PTM server sends advertisement packs and non-advertisement packs in multimedia formats are included along with the multimedia connection during processing of the authentication data of the user device.

According to an embodiment herein, a PTM comprises a Hypertext Transfer Protocol (HTTP), a Session Initiation Protocol (SIP) and an Extensible Messaging and Presence Protocol (XMPP). The plurality of protocols for a multimedia data transfer and floor control comprises a Real Time Transport Protocol (RTP) and Real Time Transport Control Protocol (RTCP).

The various embodiments herein provide a Push-to-Multimedia (PTM) system for sharing multimedia information between at least two user devices. The PTM system includes at least one user device with a PTM application installed therein, a Push-To-Multimedia (PTM) server for user management like floor control, tearing down the session and media forwarding or replication of one-to-one communication or one-to-group communication, an Authentication Server for authenticating the at least two user devices with a International Mobile Equipment Identity (IMEI), International Mobile Subscriber Identity (IMSI) and Cell ID. The system further includes a Group and List Management Server (GLMS) for verifying one or more user devices with the Cell ID, Mobile Network Code (MNC), Mobile Country Code (MCC), Local Area Code (LAC), International Mobile Equipment Identity (IMEI) and International Mobile Subscriber Identity (IMSI). The PTM server creates a multimedia data connection for sharing multimedia information between the at least one user device and the target user device.

According to an embodiment herein, the PTM server stores a stream of multimedia data sent to the target user when the target user does not answer to the connection request.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a block diagram of a Push-To-Multimedia (PTM) system, which allows users in a cellular network to connect to each other, according to an embodiment herein.

FIG. 2 is a block diagram illustrating the constituting parts of a Push-To-Multimedia (PTM) system, according to an embodiment herein.

FIG. 3 is an architectural diagram illustrating a Push-To-Multimedia (PTM) network and functional entities, according to an embodiment herein.

FIG. 4 is a flow diagram illustrating the working of a Push-To-Multimedia (PTM) system enabling the users to connect to each other, according to an embodiment herein.

FIG. 5 is a flow chart illustrating the steps for selecting and authenticating a target user for initiating a session, according to an embodiment herein.

FIG. 6 is a flow chart illustrating a method of providing a PTM application in the user device, according to an embodiment herein.

Although the specific features of the present invention are shown in some drawings and not in others. This is done for convenience only as each feature may be combined with any or all of the other features in accordance with the present invention.

### DETAILED DESCRIPTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein provide a Push-to-Multimedia (PTM) method and system for sharing multimedia information between a plurality of users in a cellular network. The PTM method includes installing a PTM application on at least one user device, connecting the user device to a Push-To-Multimedia (PTM) server through a network interface, registering the user device in the Push-To-Multimedia server, authenticating the user device, verifying the user device in a Group and List Management Server (GLMS), selecting at least one target user, creating a PTM connection file, connecting the PTM connection file to the PTM server by a verification headers, sending a connection request to one or more target users and creating a real time multimedia connection on receiving a confirmation from the one or more target users.

The multimedia information includes at least one of streaming video, broadcast video, voice, digital data, text, digitized audio, digitized still images, digitized video and digitized music. The PTM e multimedia between the users of a cellular network is establishes at least one of a multimedia connection including one-to-one connection, a one-to-group connection, an interactive connection and a non-interactive connection for sharing multimedia information among the users of the cellular network. The sharing of the multimedia information is in the form of half duplex transmission. The multimedia connection is created between the user and the PTM server by at least one of pressing a button, choosing a mark and entering a name/number in the mobile device.

The authentication of the user device includes identifying International Mobile Subscriber Identity, International Mobile Equipment Identity and Mobile and Cell ID. The verification of one or more user devices in the Group and List Management Server includes identifying a Cell ID, a Mobile Network Code (MNC), a Mobile Country Code (MCC), a Local Area Code (LAC), an International Mobile Equipment Identity (IMEI) and an International Mobile Subscriber Identity (IMSI) associated with the user devices.

The PTM connection file is created for one-to-one connection or one-to-group connection for the user device when the user device initiates a multimedia connection or sends a message by selecting one or more target users to the PTM server. The access confirmation of the user device and the verification of the Cell ID is carried out when the user device initiates a multimedia connection or sends a message by selecting one or more target users to the PTM server.

After authentication and verification based on the connection file, the PTM server starts sending the connection request to the one-to-one connection or one-to-group connection of the target users. The PTM application is pre-installed in the one or more target user devices and the one or more target user devices receives the connection request only when the PTM application installed in the target user device is active and the contact information of the target user device is stored in the PTM server. The PTM server stores a stream of multimedia data sent to the target user in an inbox of the PTM server, when the target user does not answer to the connection request. The PTM server informs the user device on a regular basis about a streaming of multimedia data to the target user. The PTM server sends a message to a target user's contact number to inform about the multimedia connection, when the target user's contact number specified by the user is not stored in the PTM server. The message informs the target user of having the PTM message and provides a download option for the PTM application for receiving the PTM message.

After each PTM connection, the target user contact number and the PTM message information is updated in the PTM server. Further by processing the authentication data of the user device, the PTM server embeds advertisement and non-advertisement packages in multimedia formats along with the multimedia connection.

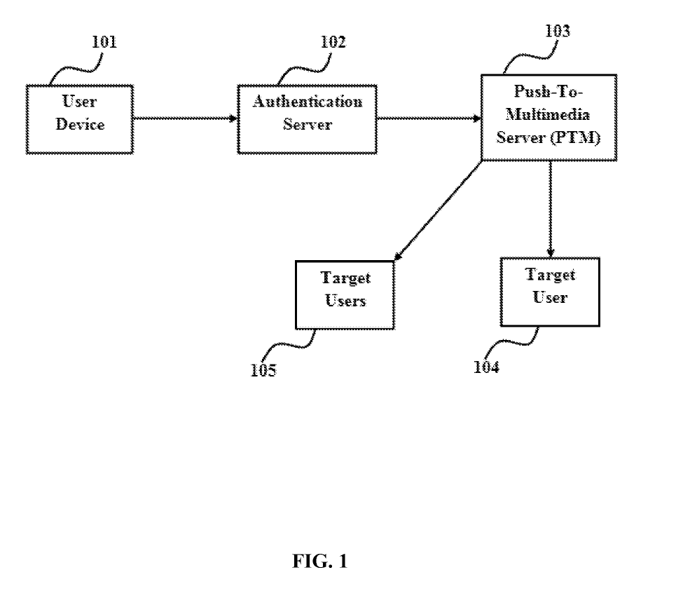

FIG. 1 illustrates a block diagram of a Push-To-Multimedia (PTM) system, which allows users in a cellular network to connect to each other, according to an embodiment herein. The PTM system allows target user/users 104, 105 to establish a multimedia connection among each other in the domain of a Local Area Network such as a broadband connection, Wide Area Network for instance Internet or within the limits of a cellular network. The PTM system enables the target user/users 104, 105 to establish at least one of a one-to-one connection 104, a one-to-group connection 105, an interactive connection and a non-interactive connection among each other. The PTM system adopts the contact number of the user in an international format (e.g. +1234567890) as the user name, which allows users to connect to each other without the need for calling. When the user press/touch a button, enter a name or number of the user on a user device 101 having a camera and a microphone, the user gets connected to each other and instantly the user is allowed to send multimedia data (voice or picture or text or video) to an intended audience or to an already subscribed user (target user 104, 105).

The user with the mobile device 101 connects to a PTM server 103 and the PTM server 103 authenticates the user device 101 in the authentication server 102 to establish multimedia connection with the target users 104, 105. The authentication is done based on the verifying the subscriber details including International Mobile Subscriber Identity (IMSI), International Mobile Equipment Identity (IMEI) and Mobile and Cell ID in the authentication server 102.

The communication between the user device 101, the PTM server 103, the authentication server 102 and the target users 104 and 105 are done through a plurality of protocols. The plurality of protocols for a PTM session set-up includes a Hypertext Transfer Protocol (HTTP), a Session Initiation Protocol (SIP) and an Extensible Messaging and Presence Protocol (XMPP). The plurality of protocols for a multimedia data transfer and floor control includes a Real Time Transport Protocol (RTP) and Real Time Transport Control Protocol (RTCP).

The HTTP (or SIP) is a text-based application layer protocol and the XMPP is the HTTP binding for the users behind restricted firewalls. In the PTM system, the PTM applications HTTP/XMPP (or SIP) messages are carried in User Datagram Protocol (UDP) packets for transmission over Internet Protocol (IP). Similarly, the RTCP signaling is also transferred using User Datagram Protocol (UDP) over Internet Protocol (IP). The h.264 (or similar codec) coded multimedia data is sent in RTP packets, which in turn are carried over UDP over IP.

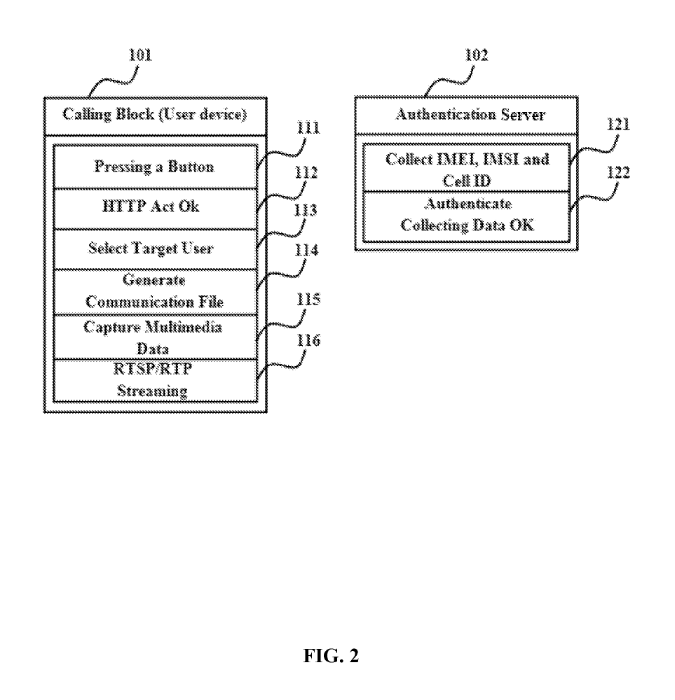

FIG. 2 illustrates constituting parts of a Push-To-Multimedia (PTM) system, according to an embodiment herein. The constituting parts of the PTM system include a calling block 101 and an authentication block 102. The calling block 101 enables the user to perform the following steps. The user launches a PTM application by pressing a button, choosing a mark or entering a name or mobile number 111 in the user device 101. The user selects multimedia data to be sent to the target user and request the PTM server to Activate Hyper Text Transfer Protocol (HTTP) by sending HTTP ACT request. The PTM server activates the HTTP and sends HTTP Act OK 112 to the user as an acknowledgement. The user then selects the target user's contact 113 or target user's business code. A communication file 114 is generated by the called user to the target users 113, which includes creating target users numbers individually or in groups or in the format of a number, or business code. The communication file 114 is provided with a header, which includes the starting and target point of the connection, location and time information, and other user data. The communication file 114 further has a body, which includes the information about the connection through the server and the user identity on the PTM server. The multimedia data to be sent to the target user 113 is captured 115 in the user device 101. The captured multimedia data 115 is streamed to the target user via PTM server. A Real-Time Streaming Protocol (RTSP) is adopted for streaming 116 the captured multimedia data 115 to the target user 113 via PTM server. The Real-Time Streaming Protocol allows streaming 116 and controlling the captured multimedia data delivered to the target user 113 via PTM server using a Real-Time Transfer Protocol (RTP).

The authentication block 102 includes authenticating or verifying the user device through the Cell ID, Mobile Network Code (MNC), Mobile Country Code (MCC), Local Area Code (LAC), International Mobile Subscriber Identity (IMSI) and International Mobile Equipment Identity (IMEI) 121. The verification of the communication file 114 generated in the calling block 101 and the streaming of the multimedia data 116 to the target user 113 is possible only when, at least two parameters of International Mobile Subscriber Identity (IMSI), International Mobile Equipment Identity (IMEI) and Cell ID remain correct. When at least two parameters of International Mobile Subscriber Identity (IMSI), International Mobile Equipment Identity (IMEI) and Cell ID remain correct, the Authentication block sends an Authenticate Collecting Data Ok 122 command to the user device as an acknowledgment.

The user needs to register his/her device with the PTM server for the first time by configuring the user device with the PTM server. The configuration of the user device requires Cell ID, Mobile Network Code (MNC), Mobile Country Code (MCC), Local Area Code (LAC), International Mobile Subscriber Identity (IMSI) and International Mobile Equipment Identity (IMEI). All these parameters are stored in the PTM server and verified during each time to establish a connection for broadcasting multimedia data.

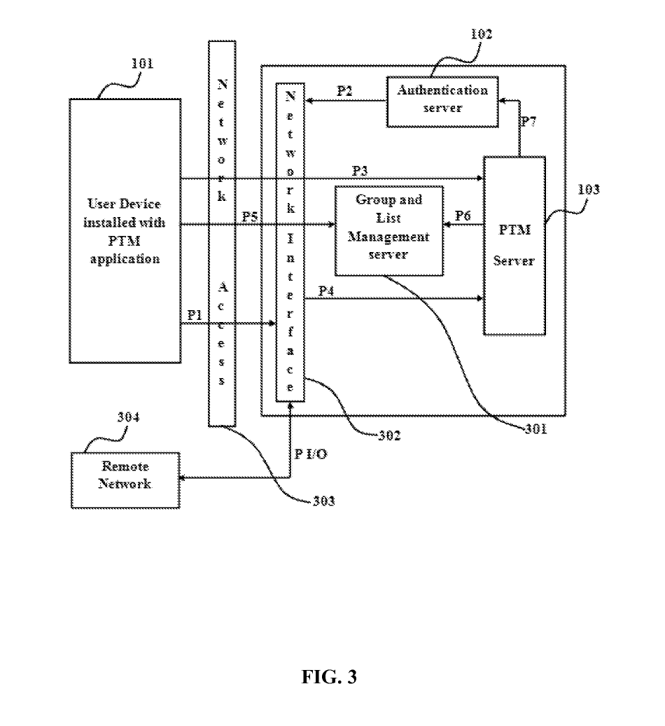

FIG. 3 is an architectural diagram illustrating the Push-To-Multimedia (PTM) network and functional entities, according to an embodiment herein. A PTM client software (or application) is installed in the user device 101 to establish a connection with another user for the first time for multimedia data transfer. The PTM application installed in the user device 101 communicate with the PTM server 103 (P3) over a network interface 302 (P1). The user device 101 includes a camera, a microphone or any other components with data capture capabilities. The PTM server 103 is responsible for user device 101 management like floor control, breaking down the session and media forwarding or replication in case of one-to-one connection or one-to-group connection, respectively. The network interface 302 and access network 303 elements (P1) provide the required connectivity services between the user device 101 and the PTM server 103 (P3). The PTM server 103 elements include an Authentication server 102, a Group and List Management Server (GLMS) 301. The PTM servers along with its elements are responsible for authentication, authorization and accounting (AAA) function of the user device and the target users. The Group and List Management Server (GLMS) 301 allow the user device 101 (P5) to create and maintain group lists for PTM services. The user device 101 communicates with the GLMS 301 (P5) over the user device 101 to Authentication Server 102 interface (P2). The PTM server 103 communicates with the Group and List Management Server 301 (P6) to collect the target user device parameters like the Cell ID, Mobile Network Code (MNC), Mobile Country Code (MCC), Local Area Code (LAC), International Mobile Subscriber Identity (IMSI) and International Mobile Equipment Identity (IMEI). Then the PTM server 103 connects to the Authentication server 102 to authenticate the target users' device by verifying the Cell ID, Mobile Network Code (MNC), Mobile Country Code (MCC), Local Area Code (LAC), International Mobile Subscriber Identity (IMSI) and International Mobile Equipment Identity (IMEI). The streaming of the multimedia data to the target user is possible only when, at-least two parameters of International Mobile Subscriber Identity (IMSI), International Mobile Equipment Identity (IMEI) and Cell ID remain correct.

The multimedia data from the PTM server can also be sent to the remote networks 304, such as forwarding or sharing the multimedia data to a broadcasting entity such as “CNN”, from an employee mobile to a corporate server such as “DHL”, send a fax to web-services such as “efax”, print an image online: “Kodak”, “HP WebOS Printers”, and so the like. The multimedia data can also be broadcasted or shared to civic agencies such as police or roadside assistants etc.

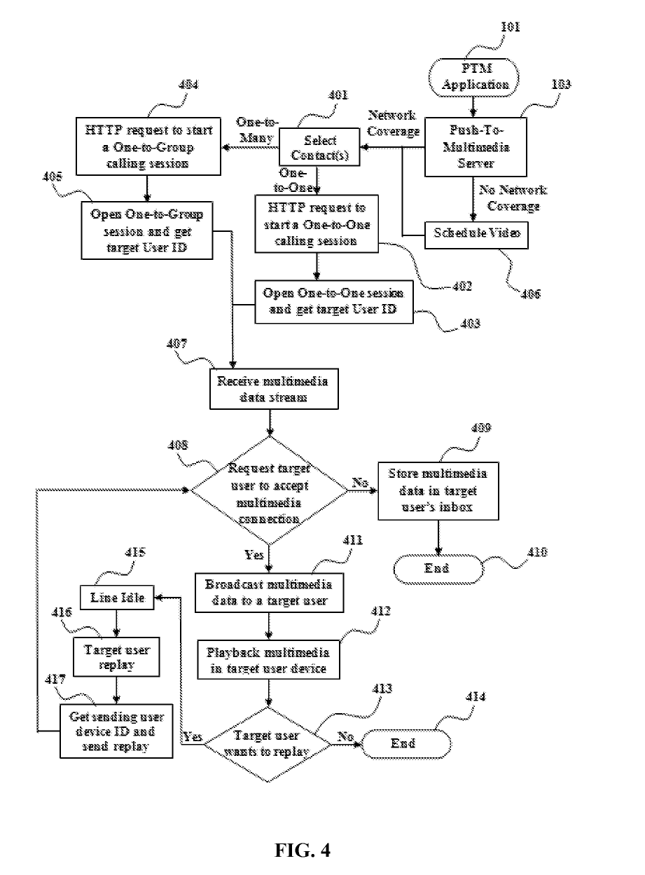

FIG. 4 is a flow diagram illustrating the working of a Push-To-Multimedia (PTM) system enabling the users to connect to each other, according to an embodiment herein. The PTM application pre-installed in the user device 101 connects to the PTM server 102 for multimedia data transfer. The PTM server 103 allows the user to schedule 406 the multimedia data to be sent to the target user if there is no network coverage, or else the PTM server 103 allows the user to select the target user's contacts 401 to establish the multimedia connection. The user is allowed to select a one-to-one connection or one-to group connection. A PTM connection file is created for a multimedia communication for the user device, when the user device initiates a multimedia connection or sends a message by selecting one or more target users to the PTM server. If the user selects one-to-one connection, the PTM application installed in the user device 101 sends an HTTP request for starting one-to-one session 402. Then the PTM server 103 opens one-to-one session between a sending user 101 and the target user and gets target user's ID via HTTP request 403. Similarly, if the user selects one-to-group connection, the PTM application installed in the user device 101 sends an HTTP request for starting one-to-group connection 404. Then the PTM server 103 opens one-to-group session between a sending user and the target users and gets target users ID via HTTP request 405.

After selecting the target users to send the multimedia data, the PTM server 103 start receiving first stream of the multimedia data 407 over a HTTP pipelining from the sending users device 101. The PTM server 103 then sends an HTTP request for the target user to accept the multimedia connection 408. Upon accepting the multimedia connection by the target users, the PTM server 103 establishes the multimedia connection between the sending user 101 and the target user and broadcasts the multimedia data to the target user via HTTP pipelining 411. The PTM application installed in the target user device 101 receives the multimedia data from the PTM server 103 and playback the multimedia data on the target user device 412. Once the multimedia data is received completely by the target device, the PTM server 103 allows the target device to replay back to the sending user 413. Since the sharing of multimedia information between the user device 101 (sending user) and the target device is in the form of half-duplex through a telecommunication media, the target device must wait (until the line is idle 415) or wait for the PTM server 103 to stop transferring multimedia before replaying. Once the transfer of multimedia data to the target user device is stopped, the PTM server 103 pulls the sending user device ID 417 and allows the target device to replay back 416 to the sending user 101.

If the target user does not answer to the HTTP request for the multimedia connection sent by the PTM server 103, the PTM server 103 pulls or stores the multimedia data in a target user's inbox. If the target user rejects the HTTP request for the multimedia connection sent by the PTM server 103, the PTM server 103 discards the session or ends the session 414 and informs to the sending user about the discarding of the session 414.

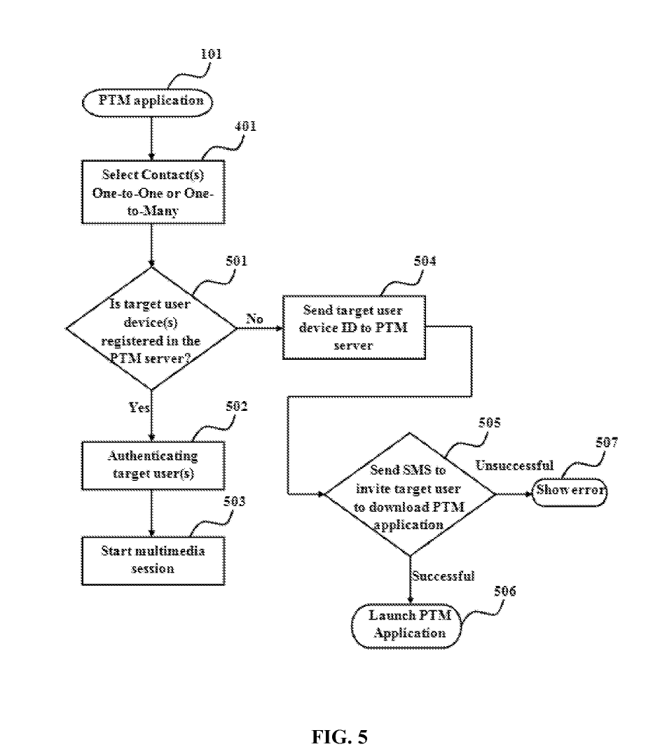

FIG. 5 is a flowchart illustrating the steps for selecting and authenticating one or more target user for initiating a session, according to an embodiment herein. The PTM application pre-installed in the user device 101 connects to the PTM server for multimedia data transfer. The PTM server allows the user to schedule the video or multimedia data to be sent to the target user if there is no network coverage, or else the PTM server allows the user to select the target user's contacts 401 to establish the multimedia connection. The user device is allowed to select one-to-one or one-to group connections. After selecting the target users to send the multimedia data, the PTM server verifies the target user device by checking whether the target user device(s) is registered in the PTM server 501. If the target user device is registered in the PTM server, the target user device is authenticated 502 in the authentication server and the connection request is sent to the target user. Upon accepting the connection request by the target user, the multimedia session is established 503 between the sending user and the target user.

If the target user device is not registered in the PTM server, the target user registers in the PTM server by providing target user device ID such as phone number or Cell ID or Business ID 504. Once the target user device is registered in the PTM server, the PTM server sends a message to invite the target user to download PTM application (and install the PTM application in the target user device request) 505. If the target user does not download and install the PTM application, the PTM server breaks down the session and displays an error message 507. If the target user downloads and installs the PTM application, the PTM application is launched 506 in the target user device and the PTM application is ready to accept the multimedia data streaming.

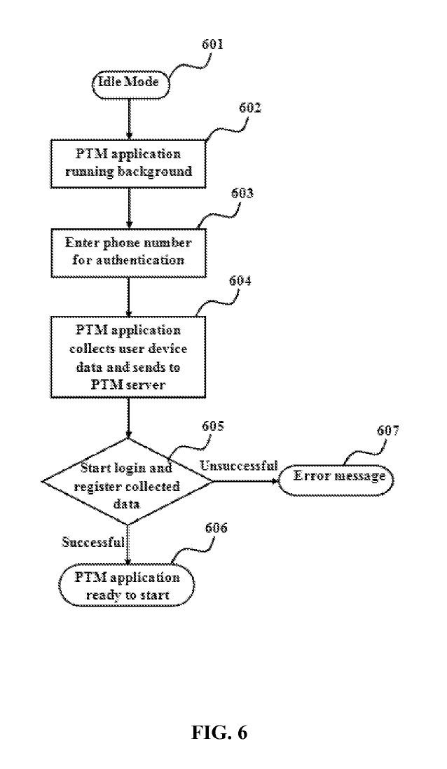

FIG. 6 is a flow diagram illustrating a method of providing a PTM application in the user device, according to an embodiment herein. The PTM application needs to be installed in a user device to establish a multimedia connection between the user device and target device. If the PTM application is running in the background 602, the user device can start multimedia connection by entering the phone number or Cell ID or business ID of the target user device. The user device can also receive connection request from the target user device to start the multimedia connection. If the PTM application is not activated in the user device and the target user device, it is not possible to establish a multimedia connection.

The PTM application is activated or launched in the user device by entering the phone number or name or Cell ID or Business ID of the user device 603. Once the PTM application is launched, the PTM application sends the entered details of the user device to the PTM server 604 for authenticating the user device. The PTM server verifies the user device details, if the verification is successful the PTM server allows the user device to login and register the collected user device details 605. Once the user device is registered, the PTM application is ready to start 606. Then the PTM application allows user to select target users and send request for the PTM server to start the connection for multimedia data transfer (or broadcasting). If the user device verification is unsuccessful, the PTM application displays error message 607 and the PTM server does not allow the PTM application to start the multimedia connection.

The embodiments of the present disclosure allow the users to establish a multimedia connection among themselves through a server only by pressing or touch a PTM key, entering a Phone Number or a Name or a Cell ID. The PTM system of the present disclosure, establishes the multimedia connection in one-to-one or one-to-group in the form of a half-duplex communication. The PTM system also establishes the multimedia connection in Ad-hoc group communication where the user is allowed to select more than one user and invites them to join in a session. The PTM system also provides for a pre-arranged group communication where the participants in the session are defined beforehand. The PTM server invites the rest of the participants when a certain member of the existing group invites others in the group session. A pre-arranged PTM group has a permanent Number (SIM) by which all the group members can be contacted.

The PTM system also establishes the multimedia connection as a chat group communication where the user join and leave an existing chat group as time goes by. The chat group session is established as soon as the first user joins in.

The PTM system of the present disclosure is a safe and secured multimedia communication. The user identification in the PTM system is based on combined user mobile phone and SIM card number. This implies that if SIM card or mobile phone is changed the user needs to register once again for new User ID.

The multimedia data transferred using PTM system includes an image which is a high quality picture tagged with user option of time/date and GPS, a fax which is a high quality image, a pre-recorded high quality video and a Live video.

The PTM system of the present disclosure allows the user to transfer or communicate multimedia data to a broadcasting entity such as CNN, BBC. etc from an employee mobile (user device) to a corporate server such as DHL, to send a fax to web-services such as efax, to print an image online through Kodak, HP Web-OS Printers, to civic agencies such as police, roadside assistant, hospital to deliver a Multimedia Mobile Coupons, to purchase Virtual SIM, etc.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

It is also to be understood that the following claims are intended to cover all of the generic and specific features of the embodiments described herein and all the statements of the scope of the embodiments, which as a matter of language might be said to fall there between.

What is claimed is:

1. A Push-to-Multimedia method for sharing multimedia information between users in a cellular network, the method comprising:
installing a PTM application on at least one user device;
connecting the at least one user device to a Push-To-Multimedia (PTM) server through a network interface;
registering the at least one user device in the Push-To-Multimedia server;
authenticating the at least one user device;
verifying the at least one user devices in a Group and List Management Server (GLMS);
selecting at least one target user;
creating a PTM connection file;
connecting the PTM connection file to the PTM server by a verification header;
sending a connection request to the at least one target users; and
creating a real time multimedia connection on receiving a confirmation from the at least one target user.

2. The method according to claim 1, wherein the multimedia information comprises at least one of streaming video, broadcast video, voice, digital data, text, digitized audio, digitized still images, digitized video and digitized music.

3. The method according to claim 1, wherein multimedia connection between the at least one user device and the at least one target user of a cellular network is created in the form of half duplex transmission.

4. The method according to claim 1, wherein the multimedia connection between the at least one user device and the at least one target user includes at least one of a one-to-one connection, a one-to-group connection, an interactive connection and a non-interactive connection.

5. The method according to claim 1, wherein authenticating the at least one user device in the PTM server comprises identifying International Mobile Subscriber Identity (IMSI) number, International Mobile Equipment Identity number (IMEI) and Cell Phone Identity number.

6. The method according to claim 1, wherein the verification of the at least one user device in the Group and List Management Server includes identifying a Cell ID, a Mobile Network Code (MNC), a Mobile Country Code (MCC), a Local Area Code (LAC), an International Mobile Equipment Identity (IMEI) and an International Mobile Subscriber Identity (IMSI) associated with the user devices.

7. The method according to claim 1, wherein a PTM connection file is created for at least one user device to establish a multimedia connection when the at least one user device initiates a multimedia communication by selecting one or more target users in the PTM server.

8. The method according to claim 1, wherein access confirmation of the at least one user device and verification of the Cell ID is carried out when the user device initiates a multimedia communication by selecting at least one target user in the PTM server.

9. The method according to claim 1, wherein the PTM server starts sending the connection request to establish at least one of a one-to-one connection and a one-to-group connection with the target users based on the connection file.

10. The method according to claim 1, wherein a PTM application is pre-installed in the at least one target user device where target user devices receives the connection request when the PTM application is active and the contact information of the plurality of target user device is stored in the PTM server.

11. The method according to claim 1, wherein the PTM server stores a stream of multimedia information sent to the at least one target user by the at least one user device, when the at least one target user does not answer to the connection request from the at least one user device.

12. The method according to claim 1, wherein the PTM server informs the at least one user device on a regular basis about a streaming of multimedia data to be transmitted to the at least one target user.

13. The method according to claim 1, wherein the PTM server sends a message to the at least one target user device to notify a multimedia connection invoked, when the at least one target user device is not registered with the PTM server.

14. The method according to claim 13, wherein the message informs the at least one target user of having a PTM message and provides a download option for a PTM application for receiving the PTM message.

15. The method according to claim 1, wherein the PTM server updates the target user information, user device information and PTM message information after each OTM transmission.

16. The method according to claim 1, further comprising providing an at least one of an advertisement pack and non-advertisement pack in multimedia formats along with the multimedia connection by the PTM server.

17. The method according to claim 1, wherein a PTM includes a communication protocol comprising at least one of a Hypertext Transfer Protocol (HTTP), a Session Initiation Protocol (SIP) and an Extensible Messaging and Presence Protocol (XMPP).

18. The method according to claim 1, wherein a plurality of protocols for a multimedia data transfer and floor control comprises a Real Time Transport Protocol (RTP) and Real Time Transport Control Protocol (RTCP).

19. A Push-to-Multimedia system for multimedia information sharing, the system comprising:
at least two user devices with a Push-To-Multimedia (PTM) application;
a Push-To-Multimedia (PTM) server for user management like floor control, tearing down the session and media forwarding or replication of one-to-one or one-to-group communication;
an Authentication Server for authenticating one or more user devices with a International Mobile Equipment Identity (IMEI), International Mobile Subscriber Identity (IMSI) and Cell ID; and
a Group and List Management Server (GLMS) for verifying the at least two user devices with the Cell ID, Mobile Network Code (MNC), Mobile Country Code (MCC), Local Area Code (LAC), International Mobile Equipment Identity (IMEI) and International Mobile Subscriber Identity (IMSI);
wherein the PTM server is adapted to establish a multimedia connection for sharing the multimedia information between the at least two user devices.
